(19) United States
(12) Patent Application Publication
(10) Pub. No.: US 2009/0111901 A1
(43) Pub. Date: Apr. 30, 2009

(54) Corrosion Inhibiting Protective Foam Packaging

(76) Inventor: William M. Allen, Hilton Head Isl, SC (US)

Correspondence Address: JAMES M. FRANCIS, 300 W VINE ST, STOLL KEENON OGDEN PLLC, LEXINGTON, KY, 40507, US

(21) Appl. No.: 11/926,255

(22) Filed: Oct. 29, 2007

(51) Int. Cl. C08J 9/06; C08J 9/38

(52) U.S. Cl. 521/51; 521/143; 521/50; 521/52

(57) ABSTRACT

A structural foam material comprising that contains a volatile corrosion inhibitor homogenized in the pre-thermoformed resin. The foam can be of a reticulated or open-cell type. The foam can also be of a closed-cell type that has a sufficient number of cells opened so as to permit migration of the volatilzed corrosion inhibitor.

### CROSS REFERENCE TO RELATED APPLICATIONS

This application claims priority from U.S. Provisional Application No. 60/684,333 filed on May 1, 2007. This application relates to a foam article of manufacture that possesses the ability to control rust. The entire disclosure contained in U.S. Provisional Application No. 60/684,333 including the attachments thereto, are incorporated herein by reference.

### BACKGROUND OF THE INVENTION

1. Field of the Invention

The present invention generally relates to protective packing that provides corrosion protection. More specifically, the invention relates to a solid foam article of manufacture that provides physical protection to an item either residing on, in the vicinity of, or within the foam and further providing controlled release of volatile corrosion inhibitors to said item. Even more specifically, this invention relates to non cross-linked foam and cross-linked foam formulated with a volatile corrosion inhibitor. Most specifically, the present invention relates to non-cross-linked polyolefin foam formulated with a volatile corrosion inhibitor.

2. Problems in the Art

Foam in many different forms is commonly used as a cushioning device to protect items placed on it or in it. Items that are either easily damaged or expensive are often encased in foam packing that possesses sufficient rigidity and load carrying capacity to protect the encased item from impact that may occur in storage or transit. Unlike traditional foams like expanded polystyrene (EPS), the nature of either non cross-linked or cross-linked foams, especially polyolefin foams, is such that it provides excellent protection from surface damage. Specifically, materials with cosmetically sensitive surfaces which must be protected from marring must be placed in a foam environment capable of transportation and storage without damage to the contents. Such materials are the preferred choice for reusable and returnable packaging. Closed cell foams are useful since they do not absorb fluids or moisture, which make them well suited for sealing, gasketing and insulation. However, open cell foams facilitate migration of the volatile corrosion inhibitor through the foam matrix.

Cross-linked foam packaging is often used in the automotive parts industry. The material is referred to as having a “Class A” surface and is used for parts which must maintain an aesthetic appeal which would be lost if marred or scratched. Further, by adding corrosion inhibitors to the formulation of cross-linked foams, the foam provides the additional benefit of minimization of corrosion to the surface of metallic materials. Closed-cell foam is structurally rigid and less compressible than open-cell foam because gas is trapped inside the cells which acts to inflate them thus they resist drastic deformation.

The advantages of the closed-cell foam compared to open-cell foam include its strength, higher R-value, and greater resistance to the leakage of air or water vapor. The disadvantage of the closed-cell foam is that it is denser, requiring more material, and therefore, more expense. Even though it has a better R-value, the cost per R is still higher than open-cell foam. The choice of foam should be based on the requirements for the other characteristics—strength, vapor control, available space, etc.

Open-cell foam is soft and provides cushion for the fragile object being shipped. The cell walls, or surfaces of the bubbles, are broken and air fills all of the spaces in the material. This makes the foam soft or weak because the cells are not structurally rigid but are instead pliable. The insulation value of this foam is related to the insulation value of the calm air inside the matrix of broken cells.

Volatile corrosion inhibitors were originally developed to protect ferrous metals in high humidity environments. The selection of the proper volatile corrosion inhibitor is important due to the different chemical processes through which corrosion takes place upon different metals. One volatile corrosion inhibitor may protect one type of metal while actually being somewhat corrosive to others. The most obvious example is the difference between steel and metals and alloys such as copper, gold, bronze, brass, and lead. General purpose volatile corrosion inhibitors are available to provide protection to a broad spectrum of metals and alloys.

Investigations of electrochemical behavior show that these compounds belong to a family of mixed or ambiodic inhibitors capable of slowing both cathodic and anodic corrosion processes. Active ingredients in volatile corrosion inhibitors are usually the products of a reaction between a volatile amine or amine derivative and an organic acid. The product obtained as a result of this reaction, aminocarboxylates, are the most commonly used volatile corrosion inhibitors. Cyclohexamine, dicyclohexamine, guanidine, aminoalcohols, and other primary, secondary and tertiary amine salts represent the chemical nature of volatile corrosion inhibitors. Volatile corrosion inhibitor compounds, although ionized in water, undergo a substantial hydrolysis that is relatively independent of concentration. This independence contributes to the stability of the film under a variety of conditions.

The adsorbed film of the volatile corrosion inhibitor on the metal surface causes a repulsion of water molecules away from the surface. This film also provides a diffusion barrier for oxygen, minimizing the oxygen in contact with the metal surface thus reducing corrosion via cathodic reaction. Strong inhibition of the anodic reaction results from the inhibitor having two acceptor-donor adsorption centers that form a chemical bond between the metal and the inhibitor. Adsorption of these compounds changes the energy state of the metallic surface, leading to rapid passivation that diminishes the tendency of the metal to ionize and thus corrode. In addition to preventing general corrosion on ferrous and non-ferrous metals and alloys, mixed VCIs are found to be effective in preventing galvanic corrosion of coupled metals, pitting, and, in some cases, hydrogen embrittlement.

Corrosion inhibition is critical in many industries for more than mere cosmetic reasons. Corrosion can greatly shorten the life expectancy of machinery and parts and has become extremely costly for industrial economies. In a report issued in 2001 by CC Technologies for the Federal Highway Administration, it was estimated that the annual cost to U.S. industries due to corrosion related issues was $275.7 billion.

Corrosion is also a major concern for the military as well. Machinery, parts, and even ammunition is sometimes stored for years in anticipation of use in the future. Machinery and parts are often stored in foam packaging and are coated with a corrosion inhibitor prior to storage. Unfortunately this coating has a limited useful lifespan. The coating can migrate due to gravity, thus exposing part of the metal surface to the air. It can also be applied unevenly, providing lesser or no protection to part of the surface it is intended to protect. Ideally, the item to be protected will receive a consistent supply of volatile corrosion inhibitor from the packaging material, thus extending the storage life and ensuring even distribution across the surface.

### SUMMARY OF THE INVENTION

The present invention provides a foam packaging material at least ½ inch thick that is formulated with a volatile corrosion inhibitor which vaporizes onto the surface of the packaged item to inhibit oxidation and reduction reactions at the surface of the metal, also known as cathodic and anodic corrosion. Galvanic corrosion can also be inhibited if the proper corrosion inhibitor is utilized. The term incorporate as used herein is defined to mean residing in the interstitial spaces of the polymeric matrix of the foam.

The corrosion inhibitor is incorporated into the amorphous interstitial zones of the polymer at the time of manufacture of the foam. The corrosion inhibitor survives incorporation and the manufacturing process. The manufacturing process and the formulation are carefully controlled so that the corrosion inhibitor does not interfere with the decomposition of the blowing agent utilized in the manufacture of the foam. Additionally, the heating and the foaming aid must be optimized to aid in the decomposition of the blowing agent. At the same time, in the case of the cross-linked foam the cross-linking agent concentration in the formulation must be optimized to reduce cross-linking in the press mold.

### OBJECTS OF THE INVENTION

The principal object of the invention is to provide a foam material suitable for use in packaging or storage having corrosion inhibiting protection incorporated into the polymeric material.

Another, more particular object of the invention is to provide a foam material suitable for use in packaging or storage having corrosion inhibiting protection incorporated into the polymeric material in a cost-effective and durable way.

Another object of the invention is to provide a foam material suitable for use in packaging or storage having corrosion inhibiting protection incorporated into the polymeric material in a way exhibits a controlled migration of the volatile corrosion inhibitor from within the foam to the surface of the foam.

Another object of the invention is to provide a foam material suitable for use in packaging having corrosion inhibiting protection incorporated into the polymeric material and possessing small cells capable of repeated compression without stress cracking.

Another object of the invention is to provide a foam material suitable for use in packaging or storage having corrosion inhibiting protection incorporated into the polymeric material such that the surface of the foam is non-abrasive and will not marr, scratch, or scuff the surface of protected items.

### DETAILED DESCRIPTION OF THE INVENTION

In the most basic form of the present invention, a corrosion inhibiting foam material is made by incorporating a volatile corrosion inhibitor or a mixture of volatile corrosion inhibitors into the polymer prior to being processed and formed into either a block or continuous plank. The volatile corrosion inhibitor interferes with anodic and cathodic corrosion and could be formulated to also provide protection for galvanic corrosion.

Corrosion is inhibited by depositing a layer of corrosion inhibitor on the metal surface to be protected. The corrosion inhibitor is transferred to the metal surface from the foam which acts as a reservoir or carrier. The corrosion inhibitor is thought to volatilize or sublime within the interstitial spaces between the foam cells and then migrate from within the interstitial spaces between the foam cells to the surface of the foam by the process of diffusion induced by the volatilization of the corrosion inhibitor from the surface of the foam or the simple physical transfer of the corrosion inhibitor to the metal surface in contact with the foam. The mechanism for diffusion is thought to be equalization induced by differences in vapor pressure.

The volatile corrosion inhibitor volatizes, typically by sublimation, while trapped within the foam carrier's interstitial spaces and migrates toward surfaces of the foam to where it is then transferred to the packaged metal either by direct contact or by redeposition as it leaves the foam matrix in a molecular form and subsequently coats the surface of the metal as it comes into contact with said metal. This forms a protective barrier or corrosion resistant seal on the surface of the metal thus preventing moisture, salt, dirt, oxygen and other corrosion inducing substances from interacting directly with the metal surface. The volatile corrosion inhibitor molecules passivate the charged surface.

Preferably, a predetermined concentrate of pelletized, solid volatile corrosion inhibitor is mixed into the polymer from which the foam is made. The resulting mix of polymer and volatile corrosion inhibitor is compounded. It is anticipated that various liquid or solid forms of volatile corrosion inhibitors would also be effective. Homogenization of the mixture, while not required to achieve a working product, aids in providing a predictable release of volatile corrosion inhibitor over time.

The density of the finished foam can range from about 0.5 pcf to about 25 pcf. Lower density foams are preferred but may not be plausible due to contrainsts imposed by the application in which the foam is utilized. Additionally, closed cell foams will need to have a effective amount of the cells opened to the interstitial areas so that the volatile corrosion inhibitor can migrate through the foam.

The preferred polymeric foam is manufactured from a polyolefin. Examples of useful polyolefins include polyethylene, polypropylene and olefin copolymers. The polymeric foam can be either cross-linked to improve its heat and ultraviolet radiation resistance compared to non-crosslinked foam or produced into a non-cross-linked sheet foam that is either reticulated or open-celled and non-reticulated. Additionally, the foam can be cut into custom shapes and sizes to meet customer needs. It is anticipated that the foam can be split, routed, water jet and die cut. When closed cell foam is utilized, it may be necessary to open an effective amount of close cells to the interstitial area so as to facilitate the migration of the volatile corrosion inhibitor.

In cross-linked foams, the initial foam block is created by manufacturing processes known to those skilled in the art but herein described as thermoforming. The cross-linked foam block produced is often referred to as a bun because it resembles bread in that it has a matrix of cells created by the blowing agent on the inside and a skin or crust on the outside as a result of the heat treatment. This skin acts to keep volatile components within the bun until the skin is breached. The cells from one preferred polyolefin, polyethylene, form as closed cells. These cells are preferably opened up by processes known to those skilled in the art to facilitate free flow of the volatile corrosion inhibitor and to further assist subsequent mechanisms to equalize the concentration of volatile corrosion inhibitor, or other volatile performance enhancing additive, across the structural foam matrix.

Reticulated foam is essentially what remains of the foam after it is reduced to its “skeleton” and can be created by two methods. The two methods of reticulation are thermal, called “zapping” and chemical, called “quenching”

Zapping is a process that involves placing a bun of foam in a very large vacuum pressure vessel known as a “zapper”. The vessel is evacuated and filled with an explosive gas mixture. The gas is ignited and a controlled flame front passes through the foam, melting the window membranes and leaving the skeletal structure intact. Zapping works with both polyester and polyether polyurethanes.

The benefit of the zapping process is a smooth, clean polished cell stand. This can be important in a clinical application such as a defoamer in a blood oxygenator or other medical applications. Another benefit is that zapping works on polyethers which perform better in applications that require hydrolytic stability at evaluated temperatures. Zapping can be done on buns for producing sheets or logs for producing rolls.

Quenching involves running the loaf of foam through a caustic bath of controlled temperature, concentration and duration. The caustic solution attacks and dissolves the window membranes, leaving only the skeletal structure. The foam is then washed, rinsed and dried. One shortcoming of this process is that it leaves a trace powder in the foam, making it unsuitable for some clinical applications. Quenching is not effective in polyether polyurethanes. One benefit of the quenching process is that it produces a rougher or more etched cell strand which holds liquids better due to surface tension. Another benefit is quenching produces softer feeling foam especially in higher porosities, which can be important for cosmetic applicators.

There are various types of open cell foams, they include polyester, polyether, polyurethane, polyimide, and melamine. Open-cell foams are not reticulated foams and can be formulated to feel very soft and pliable to very firm and board like or even hydrophilic. The cell walls, or surfaces of the bubbles, of closed cell foams are broken and air fills all of the spaces in the material. This makes the foam soft or weak. The densities of open-cell foams are around ½ to ¾ pcf (pound per cubic foot).

Closed-cell foam has varying degrees of hardness, depending its density. A normal, closed-cell insulation or flotation urethane is between 2 pcf and 3 pcf. It is strong enough to walk on without major distortion and is often utilized to bear a columnar load. Most of the cells or bubbles in the foam are not broken; they resemble inflated balloons or soccer balls, piled together in a compact configuration. This makes it strong or rigid because the bubbles are strong enough to take a lot of pressure, like the inflated tires that hold up an automobile. The cells can be full of a special gas, selected to make the insulation value of the foam as high as possible.

The resulting foam is ideal for packaging items that require protection from compression and protection of the surface from marring, scratching, and corrosion. It may be cut to meet specific customer demands and, since the volatile corrosion inhibitor is evenly distributed throughout the foam by homogenizing the mixture, will provide a consistent supply of the volatile corrosion inhibitor to the packaged item.

An effective quantity of volatile corrosion inhibitor must be incorporated into the resin. High concentrations of volatile corrosion inhibitor can inhibit the decomposition of the blowing agent used in manufacturing the foam block. Low concentrations may not provide sufficient corrosion inhibition and will shorten the lifespan of the corrosion protection the foam block offers due to a limited migration of the volatile corrosion inhibitor resulting from reduced vapor pressure differentials.

During the manufacturing process of cross-linked foam, the heating times of the hydraulic press or extruder must be prolonged and the concentration of blowing agent must be increased. These measures act to facilitate decomposition of the blowing agent and are variables controlled by the choice of volatile corrosion inhibitor and blowing agent as well as by the choice of polyolefin.

The volatile corrosion inhibitors are chosen from those commercially available to those skilled in the art as are the blowing agents, cross-linking agents, and polyolefins. It is anticipated that further advances in anti-corrosion chemistry and polymer chemistry can be readily combined with the present invention.

A blowing agent is a substance used to create the bubbles or “cells” in a foam. Typical blowing agents utilized in foam production include, but are not limited to, ethane, isobutene, propane, CFC-11, CFC-12, HCFC-22, HCFC-122, HCFC-124, HFC-152a, HFC-143a, HFC-134a, HCFC-141b, HCFC-142b, n-butane, carbon dioxide, and nitrogen or combinations of the preceding. The choice of cross-linking agent depends on the method (hot, cold, or moisture cure) by which cross-linking is achieved.

The present invention is expected to act as a reservoir and actively provide volatile corrosion inhibitors for a period of at least 2 years, depending upon the concentration of volatile corrosion inhibitors incorporated therein. In a sealed casing or package, the present invention could be expected to impart corrosion resistance upon an object that could potentially last until the seal is broken.

Alternatively, the present invention can be formulated with various biocides, viricides or combinations thereof for the creation of protective packaging that can sterilize a packaged item or maintain its sterilization. Other chemical agents capable of volatilization are anticipated to be incorporated into this invention. The use of biocides, viricides, and anti-static agents as well as various other chemical agents is herein referred to collectively as performance enhancing additives.

Example 1 is a prophetic example of a formulation containing the volatile corrosion inhibitor.

EXAMPLE 1
Typical Formulation

| | Mass % |
|---|---|
| Polyolefin resin | 75 |
| Blowing Agent | 22 |
| Volatile Corrosion Inhibitor | 3 |

What is claimed is:

1. A structural foam material comprising:
a. from about 50% to about 80% of the foam material's pre-thermoformed mass of a resin of a polymer capable of being processed into a solid foam article;
b. an effective amount of a blowing agent;
c. said foam article having an outer surface and a body, said body possessing cells and interstitial areas;
d. said foam article further possessing a density between 0.5 and 25 lbs per cubic foot; and
e. a volatile corrosion inhibitor.

2. The polymer of claim 1, wherein said polymer is a polyolefin capable of being cross-linked.

3. The material of claim 2 wherein said polyolefin is selected from the group consisting of polyethylene, polypropylene, and olefin copolymers.

4. The material of claim 2, wherein said polymer is cross-linked.

5. The material of claim 1, wherein said foam article is reticulated.

6. The material of claim 1, wherein said foam article is open-celled and non-reticulated.

7. The material of claim 1, wherein said effective amount of a blowing agent is from about 10% to about 25% of the foam material's pre-thermoformed mass.

8. The material of claim 1, wherein said material possesses antistatic properties

9. The material of claim 1, wherein said volatile corrosion inhibitor is incorporated from 0.5% to 6% of the foam material's pre-thermoformed mass.

10. The volatile corrosion inhibitor of claim 9, wherein said volatile corrosion inhibitor is a solid.

11. The material of claim 1, further comprising at least performance enhancing additive.

12. The material of claim 10, wherein said performance enhancing additive is present within said interstitial areas between said cells.

13. The material of claim 10, wherein said performance enhancing additive is selected from the group consisting of biocides and viricides.

14. The material of claim 12, wherein said performance enhancing additive migrates through said interstitial areas of said foam structure to the surface of said foam structure.

15. The material of claim 14, wherein said migration occurs due to an imbalance of vapor pressure.

16. The material of claim 14, wherein an effective amount of said cells are open so as to permit migration from said interstitial areas to said surface.

17. The material of claim 1, wherein said volatile corrosion inhibitor is capable of inhibiting galvanic corrosion.

18. The material of claim 1, wherein said volatile corrosion inhibitor is capable of inhibiting anodic corrosion.

19. The material of claim 1, wherein said volatile corrosion inhibitor is capable of inhibiting cathodic corrosion.

20. The material of claim 1, wherein said volatile corrosion inhibitor is a mixture of a plurality of volatile corrosion inhibitors.

21. The material of claim 20, wherein said mixture is capable of inhibiting both anodic and cathodic corrosion.

22. The material of claim 20, wherein said mixture is capable of inhibiting galvanic corrosion.

23. The material of claim 22, wherein said mixture is capable of inhibiting anodic corrosion.

24. The material of claim 22, wherein said mixture is capable of inhibiting cathodic corrosion.

25. The material of claim 1, wherein said foam article possesses a thermoformed surface skin.

26. The material of claim 25, wherein said skin inhibits the migration of said performance enhancing additives.

27. The material of claim 1, further comprising a pigment.

28. A structural foam material manufactured from a blend comprising:
a. from about 60% to about 80% of the foam material's pre-thermoformed mass of a polyolefin resin capable of being processed into a solid foam article;
b. from about 12% to about 20% of the foam material's pre-thermoformed mass of a blowing agent;
c. from about 2% to 6% of the foam material's pre-thermoformed mass of at least one solid volatile corrosion inhibitor; and
d. said foam article having an outer surface and a body, said body possessing cells and interstitial areas.

29. The material of claim 28, wherein said polyolefin is selected from the group consisting of polyethylene, polypropylene, and olefin copolymers.

30. The material of claim 29, wherein said polyolefin is not cross-linked.

31. The material of claim 28, further comprising an effective amount of a pigment.

32. The material of claim 28, further comprising an effective amount of a performance enhancing additive.

33. The material of claim 28, wherein said volatile corrosion inhibitor is capable of inhibiting galvanic corrosion.

34. The material of claim 28, wherein said volatile corrosion inhibitor is capable of inhibiting anodic corrosion.

35. The material of claim 28, wherein said volatile corrosion inhibitor is capable of inhibiting cathodic corrosion.

36. The material of claim 28, wherein said foam material blend contains a plurality of volatile corrosion inhibitors.

37. The material of claim 36, wherein said foam material inhibits more than one kind of corrosion mechanism.

38. The material of claim 29, wherein said foam material possesses a surface skin after being thermoformed.

39. The material of claim 38, wherein said skin is substantially impermeable to said volatile corrosion inhibitor.

40. The material of claim 29, wherein an effective amount of cells are opened to the interstitial areas.

41. The material of claim 28, wherein said foam article is a reticulated foam.

42. The material of claim 28, wherein said foam article is an open-celled, non-reticulated foam.

43. The method of evenly distributing a solid volatile corrosion inhibitor into a foam materials pre-formed mass so that, upon forming the volatile corrosion inhibitor will be incorporated within the foam material.

44. The method of claim 43, further including the method of mechanically opening up a sufficient amount of the closed cells of a closed cell foam material so as to permit the volatile corrosion inhibitor to migrate through the foam material upon volatilization.
